(19) United States
(12) Patent Application Publication
(10) Pub. No.: US 2025/0013953 A1
(43) Pub. Date: Jan. 9, 2025

(54) HARVESTING SCHEDULE RECOMMENDER

(71) Applicant: SAP SE, Walldorf (DE)

(72) Inventors: MARCUS DETTENBACH, Wiesloch (DE); Katharina Kreplin, Baden-Wurttemberg (DE); Jonas Gunst, Baden-Wurttemberg (DE)

(21) Appl. No.: 18/218,262

(22) Filed: Jul. 5, 2023

(51) Int. Cl. G06Q 10/0631; G06Q 10/0637; G06Q 50/02

(52) U.S. Cl. CPC G06Q 10/06312; G06Q 10/06375; G06Q 50/02

(57) ABSTRACT

Disclosed herein are system, method, and computer program product embodiments for generating a recommended harvesting schedule. In embodiments, input data is obtained that includes a respective representation of a crop yield curve for each crop zone in a plurality of crop zones and a set of harvesting constraints including at least one harvesting resource constraint. Based on the input data, a local search heuristic iterates over a plurality of candidate harvesting schedules to identify a current best candidate harvesting schedule and outputs the current best harvesting schedule as the recommended harvesting schedule. The iteration may include determining a solution score for each candidate harvesting schedule based at least upon a measure of a degree to which the candidate harvesting schedule satisfies the set of harvesting constraints and a total crop yield associated with the candidate harvesting schedule, and evaluating each candidate harvesting schedule based on the solution score determined therefor.

### BACKGROUND

Scheduling the harvesting of a number of fields using a limited set of harvesting equipment in a manner that achieves a maximum or desired total crop yield can present a difficult challenge for farm managers. Each field may have an optimal harvesting time, and any deviation from that optimal harvesting time may result in a lower expected yield. Due to constraints such as limitations on available harvesting equipment, it may not be possible to harvest each field at the optimal point in time. Furthermore, the effect on total yield of harvesting a field earlier or later than the optimal harvesting time may be unique for each field. Taking into account these constraints and others, such as the number of calendar days and working hours available for harvesting, the time and logistics associated with setting up each harvesting task, and the varying sizes of the fields to be harvested, can further exacerbate this challenge.

### BRIEF DESCRIPTION OF THE DRAWINGS

The accompanying drawings are incorporated herein and form a part of the specification.

FIG. 1 illustrates an example crop yield curve for a first field.

FIG. 2 illustrates an example crop yield curve for a second field.

FIG. 3 illustrates an example of an infeasible harvesting schedule.

FIG. 4 is a block diagram of a system for implementing a harvesting schedule recommender, according to some embodiments.

FIG. 5 illustrates an example of a recommended harvesting schedule, according to some embodiments.

FIG. 6 is a flowchart illustrating a process for generating a recommended harvesting schedule, according to some embodiments.

FIG. 7 is a flowchart illustrating a process for calculating a solution score associated with a candidate harvesting schedule, according to some embodiments.

FIG. 8 is a flowchart illustrating an alternative process for generating a recommended harvesting schedule, according to some embodiments.

FIG. 9 is a block diagram of an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

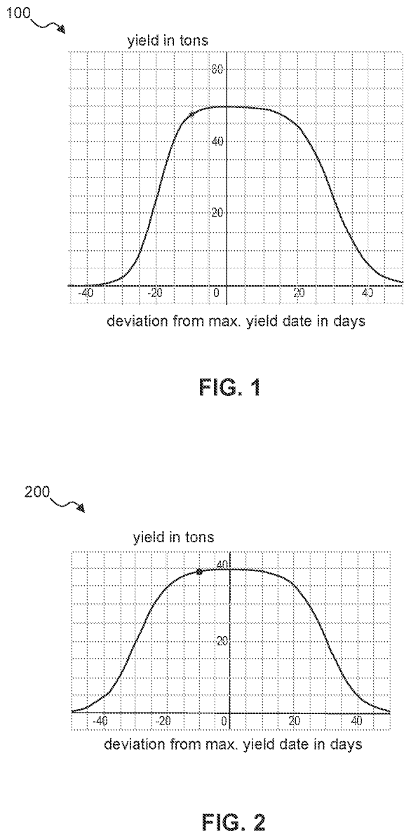

As mentioned in the Background Section, above, scheduling the harvesting of a number of fields using a limited set of harvesting equipment in a manner that achieves a maximum or desired total crop yield can present a difficult challenge for farm managers. Each field may have an optimal harvesting time, and any deviation from that optimal harvesting time may result in a lower expected yield. Furthermore, the effect on total yield of harvesting a field earlier or later than the optimal harvesting time may be unique for each field. An example of this concept is presented in FIGS. 1 and 2. In particular, FIG. 1 illustrates an example yield curve 100 for a first field and FIG. 2 illustrates an example yield curve 200 for a second field. For each field, the optimal harvesting time occurs at time t=0. As shown in FIG. 1, if the first field is harvested ten days earlier than the optimal harvesting time then the total yield for the first field will be reduced by approximately 2.5 tons. However, as shown by FIG. 2, if the second field is harvested ten days earlier than the optimal harvesting time then the total yield from the second field will be reduced by approximately 1.2 tons.

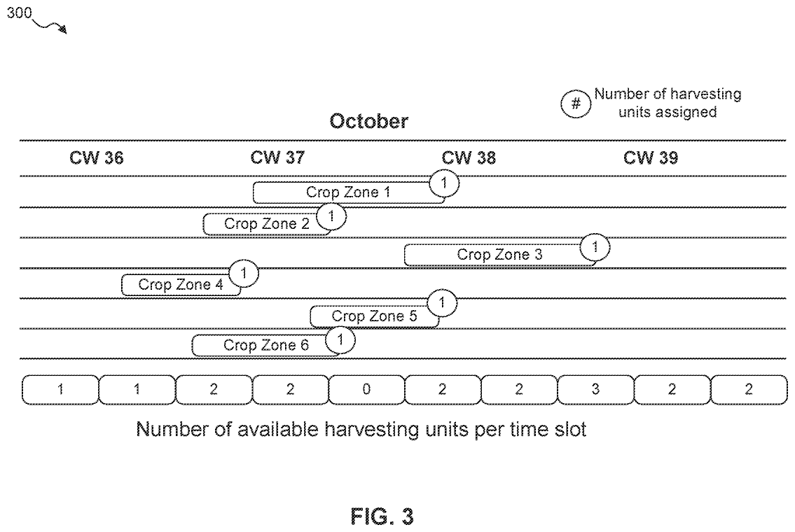

Due to constraints such as limitations on available harvesting equipment, it may not be possible to harvest each field at the optimal point in time. This is illustrated by FIG. 3, which shows an example harvesting schedule 300. In example harvesting schedule 300, time is represented on the horizontal axis and comprises a series of discrete timeslots that span from calendar week (“CW”) 36 through CW 39. Each field (referred to as a “crop zone” in FIG. 3) is represented by a respective row, and the task of harvesting each field is shown as a box spanning a certain number of timeslots within the corresponding row. The number of harvesting units (an abstract representation of the harvesting equipment/machines needed to harvest a field) used during each harvesting task is shown in a circle on the right-hand corner of each box. In the bottom row is shown the number of available harvesting units per timeslot.

In example harvesting schedule 300, each field is scheduled to be harvested at its maximum yield date to maximize the total overall crop yield. However, as shown in FIG. 3, this is problematic because harvesting schedule 300 fails to take into account the capacity of the harvesting units. Thus for example, during CW 37, crop zones 1, 2 and 6 are scheduled to be concurrently harvested using a total of three harvesting units, when only two are available. Likewise, between calendar week 37 and 38, crop zones 1 and 5 are scheduled to be concurrently harvested using a total of two harvesting units, when none are available. Thus, harvesting schedule 300 cannot actually be implemented due to harvesting resource constraints. This may be addressed by time shifting certain harvesting tasks away from the optimal yield time for certain fields. However, because each field may have a different yield curve, the impact of such shifting on the total crop yield can vary depending upon which field is involved and the size of the shift.

In addition to harvesting resource constraints and time-dependent yields, there are other constraints that must be considered when creating a harvesting schedule. These may include, for example, the number of calendar days and working hours available for harvesting, the time and logistics associated with setting up each harvesting task (e.g., moving harvesting equipment and/or personnel to a field), and the varying sizes of the fields to be harvested (e.g., which may impact the amount of harvesting equipment that can be deployed to a given field at one time). Given the number of constraints and the large number of possible harvesting schedule permutations, the task of generating a harvesting schedule that can maximize or nearly maximize the total crop yield becomes one that cannot be solved by the human mind, and potentially one that cannot even be solved by many computing-based approaches within a reasonable timeframe or at all.

Provided herein are system, method and/or computer program product embodiments, and/or combinations and sub-combinations thereof, for implementing a harvesting schedule recommender that addresses at least some of the foregoing challenges. In embodiments, the harvesting schedule recommender is capable of generating a recommended harvesting schedule that maximizes or nearly maximizes a total crop yield across a plurality of fields using a plurality of harvesting resources in a manner that takes into account a set of crop yield curves respectively associated with the plurality of fields and a set of harvesting constraints that include at least one harvesting resource constraint. In embodiments, the harvesting scheduler recommender utilizes a computer-implemented local search heuristic to iterate over a plurality of candidate harvesting schedules and evaluate them in accordance with a solution scoring scheme that takes into account the degree to which each candidate harvesting schedule satisfies the set of harvesting constraints and the total crop yield associated with candidate harvesting schedule. The current best harvesting schedule selected by the local search heuristic at the time a stopping condition is met is output as the recommended harvesting schedule.

As will be illustrated herein, embodiments model the harvest scheduling problem as a constraint-based optimization problem that can be efficiently solved by the aforementioned local search heuristic. In contrast, an optimal solution approach may not be capable of solving the harvesting scheduling problem in a reasonable time frame or at all. For example, in accordance with an optimal solution approach, the optimization problem may be too large to fit into memory of a computer system, require too much time to compute, or be simply too hard to solve.

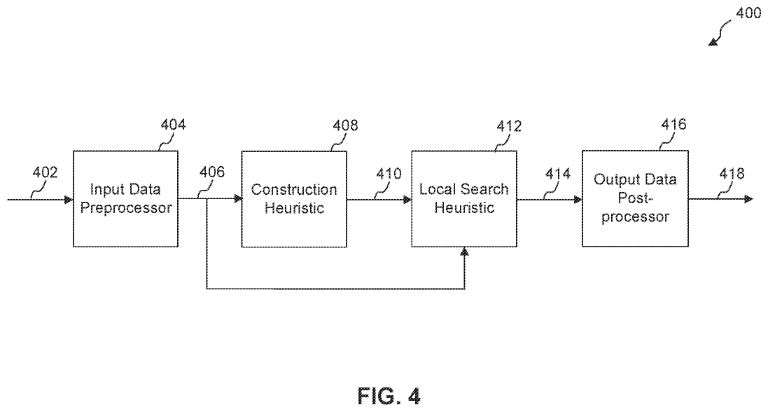

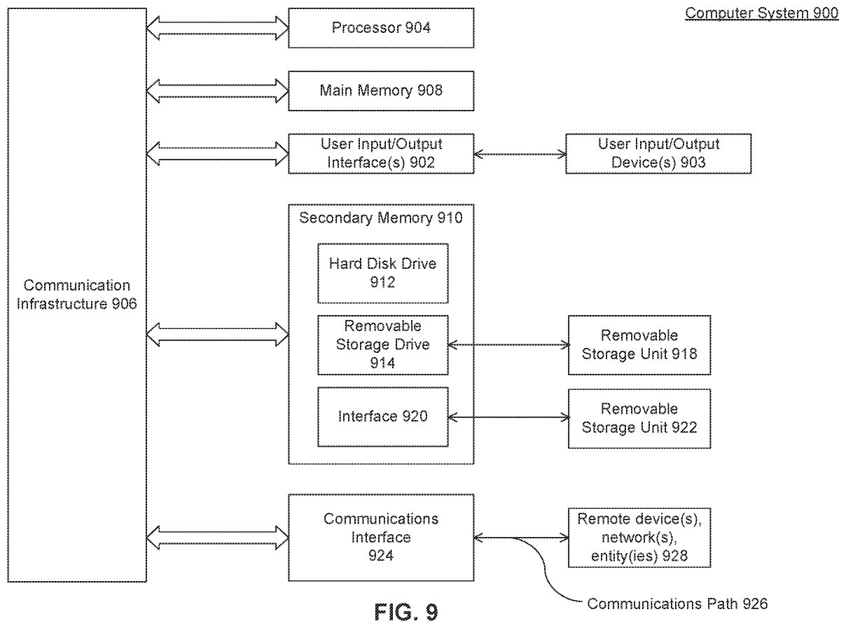

FIG. 4 is a block diagram of a system 400 for implementing a harvesting schedule recommender, according to some embodiments. As shown in FIG. 4, system 400 includes an input data preprocessor 404, a construction heuristic 408, a local search heuristic 412 and an output data post-processor 416. The components of system 400 may be individually or collectively implemented by processing logic that can comprise hardware (e.g., circuitry, dedicated logic, programmable logic, microcode, etc.), software (e.g., instructions executing on a processing device), or a combination thereof. In an embodiment, the components of system 400 are implemented as one or more software processes executing on one or more processor-based computer systems, such as computer system 900 as described below in reference to FIG. 9. Each of the components of system 400 will now be described.

Input data preprocessor 404 is configured to receive raw input data 402 and process it to create input data 406 that is in a form suitable for processing by construction heuristic 408 and local search heuristic 412. Raw input data 402 may be received from a variety of sources. For example, raw input data 402 may be received from one or more data stores (e.g., databases or files), user interfaces, applications, and/or services, and may be formatted in a variety of different ways.

In embodiments, input data 406 includes planning parameters, crop zone information, and harvesting resource information. Each of these types of input will now be described.

In embodiments, the planning parameters may include a planning horizon start time, a planning horizon end time, a working hours start time, a working hours end time, a maximum number of harvesting tasks per crop zone, and a minimum duration of a harvesting task.

The planning horizon start time and the planning horizon end time collectively define a planning horizon. In embodiments, any scheduled harvesting task must start after the planning horizon start time and end before the planning horizon end time. In embodiments, the planning horizon start time and the planning horizon end time are specified as calendar dates, although these parameters may be specified in other ways as well.

The working hours start time and the working hours end time collectively define a working hours' time window. In embodiments, this window is considered when computing the start time and the end time of a harvesting task. For example, in embodiments, a harvesting task can only start or end within the working hours' time window. In embodiments, each of the working hours start time and the working hours end time is specified in terms of a particular hour and minute, although these parameters may be specified in other ways as well.

In embodiments, a field or crop zone can be harvested in multiple harvesting tasks distributed in time, rather than only in a single harvesting task. The maximum number of harvesting tasks per crop zone may provide an upper limit for the number of harvesting tasks into which the harvesting of a field or crop zone can be split. In embodiments, this parameter may be specified as a positive integer value.

A harvesting task may require a certain amount of set up time, e.g., to account for transporting harvesting equipment and/or personnel to a field. Therefore, it may be beneficial to avoid scheduling harvesting tasks that are shorter in duration than the set up time or that barely exceed the set up time. The minimum duration of a harvesting task parameter sets a lower limit of the duration of harvesting tasks. In embodiments, the model of the harvest scheduling problem implemented by system 400 utilizes a discrete concept of time in which planning is carried out in discrete timeslots, wherein each timeslot represents a fixed amount of time. In embodiments, the length of a timeslot may be a user-configurable aspect of the harvesting schedule recommender, thereby allowing users to obtain recommended harvesting schedules with varying levels of temporal granularity. In accordance with such embodiments, the minimum duration of a harvesting task parameter may be specified as a particular number of timeslots. However, this parameter may be specified in other ways as well.

The crop zone information is input data concerning the set of fields or crop zones that should be harvested. As used herein, the term “crop zone” refers to one or more land areas used for growing crops. A field comprises one non-limiting example of a crop zone. In embodiments, the crop zone information may include, for each crop zone, a crop zone identifier, an area, a maximum number of harvesting units, and a yield curve.

The crop zone identifier may comprise an identifier of a crop zone that distinguishes it from other crop zones for which planning is being carried out. In embodiments, the crop zone identifier may comprise a unique alphanumeric string that is assigned to each crop zone, although this is only an example and other types of identifiers may be used.

The area is a measure of the size of a crop zone. In embodiments, the area is used to compute the workload for a crop zone. The workload of a crop zone may represent the amount of time it takes to harvest that specific crop zone. In embodiments, the area may also be used to compute a total expected yield for a crop zone. Various units of measurement may be used to represent the area (e.g., square kilometer, square meter, hectare, square mile, or square yard).

The maximum number of harvesting units specifies an upper limit on a number of harvest units that can work on a particular crop zone at the same time. As previously noted, a harvesting unit may comprise an abstract representation of the harvesting equipment/machines needed to harvest a crop zone. The size of a crop zone may impact how many harvesting units can concurrently work the crop zone without conflicting with each other.

In embodiments, for each crop zone, a yield curve (such as the yield curves previously discussed with respect to FIGS. 1 and 2) is computed or otherwise obtained. The yield curve may be computed or obtained, for example, using a prediction algorithm that takes into account historical data for the crop zone, or in various other ways. The yield curve may specify an optimal harvesting time. This is t=0 in the examples of FIGS. 1 and 2. Any deviation from the optimal harvesting time may result in lower expected yield.

In embodiments, the yield curve comprises discrete yield estimations that constitute a time series. For example, the discrete yield estimations may be represented by a set of tuples, wherein each tuple comprises a timestamp and a corresponding yield. The yield may be expressed using a variety of units of measurement, such as tonnes/hectare, tons/acre, bushels/hectare, bushels/acre, etc. However, these are only examples and the discrete yield estimations may be represented in other ways.

In embodiments, input data preprocessor 404 maps a time series of data points that represents the yield curve of a crop zone to a particular number of timeslots, wherein the number of timeslots may be dependent upon the planning horizon and the timeslot length. To conduct such a mapping, an extrapolation technique (e.g., static step function mapping or dynamic second order polynomial fit) may be used. An extrapolation technique may be used to determine timeslot-specific yield values, for example, when the yield curve is shorter than the planning horizon. Furthermore, to conduct such a mapping, an interpolation technique (e.g., static step function mapping or dynamic spline interpolation) may be used. An interpolation technique may be used to determine timeslot-specific yield values, for example, when the data points in the yield curve are spaced further apart in time than the timeslots in the planning horizon.

The harvesting resource information is input data relating to harvesting resources. In embodiments, harvesting resources are represented as harvesting units, which comprise abstract representations of harvesting equipment or machines. In further accordance with such embodiments, the harvesting resource information may include, for each harvesting unit, a harvesting unit identifier, a speed, and an availability schedule.

The harvesting unit identifier may comprise an identifier of a harvesting unit that distinguishes it from other harvesting units. In embodiments, the harvesting unit identifier may comprise a unique alphanumeric string that is assigned to each harvesting unit, although this is only an example and other types of identifiers may be used.

The speed associated with a harvesting unit may specify an amount of crop zone area that can be harvested by the harvesting unit per unit time.

The availability schedule associated with a harvesting unit may specify times when the harvesting unit is available for harvesting and times when the harvesting unit is unavailable for harvesting. In embodiments, harvesting unit availability is considered so that the recommended harvesting schedule can avoid using more harvesting units than are available at any given time.

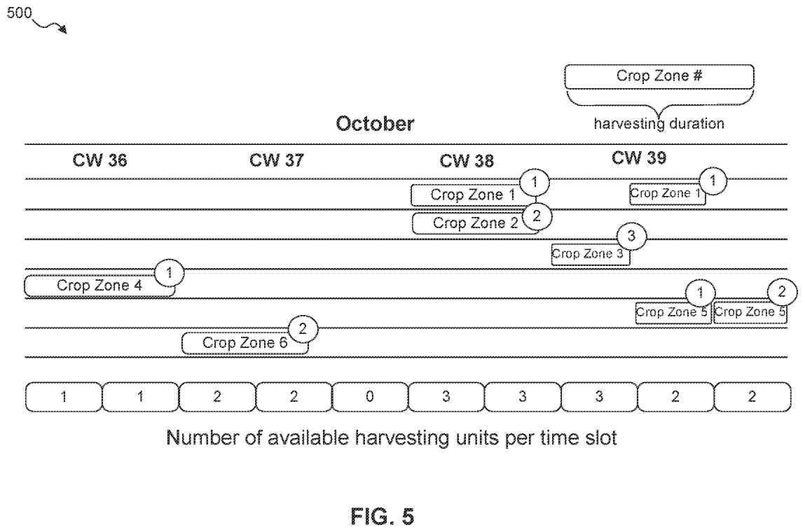

In embodiments, the recommended harvesting schedule generated by system 400 identifies the number of harvesting units that should execute a given harvesting task, but not which specific harvesting units should be scheduled (an example recommended harvesting schedule is discussed below in reference to FIG. 5). To make this possible, embodiments calculate an average harvesting speed for all the harvesting units and then apply the average harvesting speed for planning. Using the average harvesting speed and the area associated with a crop zone, the workload of harvesting a crop zone may be computed. For example, a field with an area of 10 hectares can be harvested by a harvesting unit with a harvesting speed of 2 hectares per hour in 5 hours.

Returning now to the description of FIG. 4, construction heuristic 408 may be configured to receive input data 406 and, based thereon, generate an initial harvesting schedule 410. A construction heuristic may comprise a heuristic method that starts with an empty solution and repeatedly extends the current solution until a complete solution is obtained. Any suitable construction heuristic currently known in the art or hereinafter developed may be used to implement construction heuristic 408. Initial harvesting schedule 410 generated by construction heuristic 408 is passed to local search heuristic 412.

Local search heuristic 412 (or some other component of system 400) may be configured to calculate a solution score for initial harvesting schedule 410. The solution score for initial harvesting schedule 410 may be determined based at least upon a measure of a degree to which initial harvesting schedule 410 satisfies a set of harvesting constraints defined by input data 406 and a total crop yield associated with initial harvesting schedule 410. Local search heuristic 412 may also be configured to designate initial harvesting schedule 410 as the current best harvesting schedule.

Local search heuristic 412 may be further configured to identify a set of neighbor harvesting schedules to the current best harvesting schedule in a search space that encompasses a plurality of candidate harvesting schedules. Local search heuristic 412 may be configured to calculate a solution score for each neighbor harvesting schedule in the set of neighbor harvesting schedules using the same scoring approach described above for initial harvesting schedule 410. That is to say, local search heuristic 412 may be configured to calculate the solution score for each neighbor harvesting schedule based at least upon a measure of a degree to which the neighbor harvesting schedule satisfies the set of harvesting constraints defined by input data 406 and a total crop yield associated with the neighbor harvesting schedule. Local search heuristic 412 may be further configured to identify the neighbor harvesting schedule having a solution score that most improves over the solution score of the current best harvesting schedule and to designate the identified neighbor harvesting schedule as the current best harvesting schedule.

Local search heuristic 412 may be further configured to iteratively perform the steps described in the preceding paragraph until a stopping criterion is met, after which local search heuristic 412 may output the current best harvesting schedule as a recommended harvesting schedule 414.

Local search heuristic 412 may be implemented using any suitable local search heuristic currently known in the art or hereinafter developed. For example, Tabu Search or Simulated Annealing may be used to implement local search heuristic 412, although these are merely two examples.

In embodiments, local search heuristic 412 may be configured to calculate the solution score for a candidate harvesting schedule by calculating a hard score, a medium score and a soft score for the candidate harvesting schedule. That is to say, in embodiments, the solution score may be composed of the hard score, the medium score, and the soft score. Local search heuristic 412 may be configured to maximize the value of these scores. In embodiments, in identifying the neighbor harvesting schedule with the most improved solution score, local search heuristic 412 may be configured to prefer an increase in a hard score over any effect on the medium score or the soft score. Furthermore, local search heuristic 412 may be configured to prefer an increase in the medium score over any effect on the soft score.

In certain embodiments, local search heuristic 412 is configured to pursue at least seven objectives. The seven objectives may be stated as: (1) do not schedule harvesting tasks of a duration less than or equal to the minimum duration; (2) do not schedule harvesting tasks that start before the start of the planning horizon; (3) do not schedule harvesting tasks that end after the end of the planning horizon; (4) do not schedule harvesting tasks that assign more harvesting units to a crop zone than the maximum number of harvesting units for that crop zone; (5) do not fail to complete the entire workload of a crop zone; (6) do not exceed the harvesting resource capacity in any time slot; and (7) maximize the total yield over all crop zones. These objectives may also be thought of as constraints to be satisfied by the recommended harvesting schedule.

In embodiments, a degree to which a candidate harvesting schedule advances two of the foregoing objectives (or satisfies two of the foregoing constraints) influences the hard score for the candidate harvesting schedule, a degree to which the candidate harvesting schedule advances two of the foregoing objective (or satisfies two of the foregoing constraints) influences the medium score of the candidate harvesting schedule, and the degree to which the candidate harvesting schedule advances one of the foregoing objectives (or satisfies one of the foregoing constraints) influences the soft score. In further accordance with such embodiments, the remaining two objectives may be modelled by using appropriate value ranges for the corresponding decision variables (i.e., the search space will not include any candidate harvesting schedules with values outside of these value ranges). A score concept is useful as the five objectives that influence the solution score cannot be compared directly.

In embodiments, objective (1) may be achieved by preventing local search heuristic 412 from exploring candidate harvesting schedules in which a harvesting task of a duration less than the minimum duration is scheduled.

In embodiments, objective (2) may be achieved by preventing local search heuristic 412 from exploring candidate harvesting schedules in which a harvesting task is scheduled before the start of the planning horizon.

In embodiments, for the five objectives that influence the scores, a respective penalty factor or weight cᵢ may be introduced. These penalty factors may be configurable (e.g., by a user of system 400) so that they can be fine-tuned to achieve a desired quality of harvesting schedule. In the following examples, specific values of cᵢ are provided by way of example, but these examples are not intended to be limiting.

In embodiments, objective (3) may be implemented by imposing a penalty on the hard score for each harvesting task of the candidate harvesting schedule that extends beyond the planning horizon end time. For example, the penalty per harvesting task may be calculated as c₁h₁², wherein c₁=−1 and h₁ is a number of time slots by which a harvesting task of the candidate harvesting schedule extends beyond the planning horizon end time. The term h₁ is squared in order to place a higher penalty on larger deviations. The penalty c₁h₁² for each harvesting task is added to the hard score.

In embodiments, objective (4) may be implemented by imposing a penalty on the hard score for each harvesting task of the candidate harvesting schedule that exceeds the maximum number of harvesting resources for its associated crop zone. For example, the penalty per harvesting task may be calculated as c₂h₂², wherein c₂=−1 and h₂ is the amount by which a harvesting task of the candidate harvesting schedule exceeds the maximum number of harvesting resources for the crop zone associated with the harvesting task multiplied by the number of timeslots in the harvesting task. The term h₂ is squared in order to place a higher penalty on larger deviations. The penalty for each harvesting task c₂h₂² is added to the hard score.

In embodiments, objective (5) may be implemented by imposing a penalty on the medium score for each crop zone of the candidate harvesting schedule that has a planned workload that deviates from the actual workload of the crop zone. For example, the penalty per crop zone may be calculated as c₃h₃², wherein c₃=−1 and h₃ is the absolute deviation between a planned workload for the crop zone as specified by the candidate harvesting schedule and an actual workload for the crop zone. The term h₃ is squared in order to place a higher penalty on larger deviations. The penalty for each crop zone c₃h₃² is added to the medium score.

In embodiments, objective (6) may be implemented by imposing a penalty on the medium score for each time slot of the candidate harvesting schedule in which the number of harvesting units scheduled to conduct a harvesting task exceeds the number of available harvesting units. For example, the penalty per time slot may be calculated as c₄h₄², wherein c₄=−1 and h₄ is, for a given time slot of the candidate harvesting schedule, an amount by which a number of harvesting units scheduled to conduct a harvesting task exceeds the number of harvesting units available. The term h₄ is squared in order to place a higher penalty on larger deviations. The penalty for each time slot c₄h₄² is added to the medium score.

In embodiments, objective (7) may be implemented by boosting the soft score by an amount equal or correlated to the total scheduled yield across all crop zones for the candidate harvesting schedule. For example, the boost per crop zone may be calculated as c₅h₅, wherein c₅=+1 and h₅ is the total scheduled yield for the crop zone. The boost for each crop zone c₅h₅ may be added to the soft score.

In embodiments, a candidate harvesting schedule that has a hard score of zero (meaning that objectives (3) and (4) have been fully achieved) may be considered a feasible harvesting schedule. Whether a candidate harvesting schedule achieves a medium score of zero (which depends on the degree to which objectives (5) and (6) have been met) may also be considered in determining whether or not the schedule is feasible. However, what constitutes a feasible harvesting schedule may vary depending upon implementation and may also be a user-configurable parameter of system 400.

In embodiments, prioritizing the hard score and the medium score over the soft score in evaluating the quality of candidate harvesting schedules ensures that the system focuses first on staying within the boundaries provided by the constraints and then, only after the constraints have been satisfied as much as possible, on maximizing the total scheduled yield across all crop zones.

As noted above, local search heuristic 412 outputs the current best harvesting schedule as recommended harvesting schedule 414 when a stopping condition is satisfied. The stopping condition may vary by implementation and may also be a user-configurable parameter of system 400. The stopping condition may be based, for example, on reaching a current best harvesting schedule that satisfies certain criteria with respect to its solution score, on reaching a time limit, or some combination thereof. For example, the stopping condition may be: stop if the hard score is 0 (harvesting schedule is feasible) and the medium and soft score have not improved after five minutes. However, this is only one example, and a wide variety of stopping conditions may be implemented.

Recommended harvesting schedule 414 output by local search heuristic 412 is provided to output data post-processor 416. Output data post-processor 416 is configured to convert recommended harvesting schedule 414 into a form suitable for presentation to a user, wherein the form may depend upon a user interface to which the schedule will be rendered. For example, output data post-processor 416 may generate a graphical user interface (GUI) representation 418 of the schedule that can be rendered to a display so that it may be viewed by a user.

FIG. 5 illustrates one example of a recommended harvesting schedule 500 that may be generated by system 400, according to some embodiments. In example harvesting schedule 500, time is represented on the horizontal axis and comprises a series of timeslots that span from CW 36 through CW 39. Each crop zone is represented by a respective row, and the task of harvesting each field is shown as a box spanning a certain number of timeslots within the corresponding row. The number of harvesting units used during each harvesting task is shown in a circle on the right-hand corner of each box. In the bottom row is shown the number of available harvesting units per timeslot.

As shown in FIG. 5, it can be seen that recommended harvesting schedule 500 satisfies certain previously-described constraints imposed by system 400. For example, none of the harvesting tasks start before or end after the planning window. Furthermore, for every time slot, the total number of harvesting units assigned to a harvesting task does not exceed the current number of available harvesting units. As also shown in FIG. 5, the harvesting of a particular crop zone may be split into multiple harvesting tasks, although system 400 may place a limit on the total number of harvesting tasks per crop zone, as previously described. Furthermore, each of the multiple harvesting tasks scheduled for a particular crop zone may have a different number of harvesting units assigned thereto.

It is noted that recommended harvesting schedule 500 is described herein by way of example only. Persons skilled in the relevant art(s) will appreciate that system 400 may generate recommended harvesting schedules that vary greatly from recommended harvesting schedule 500 both in terms of form and content.

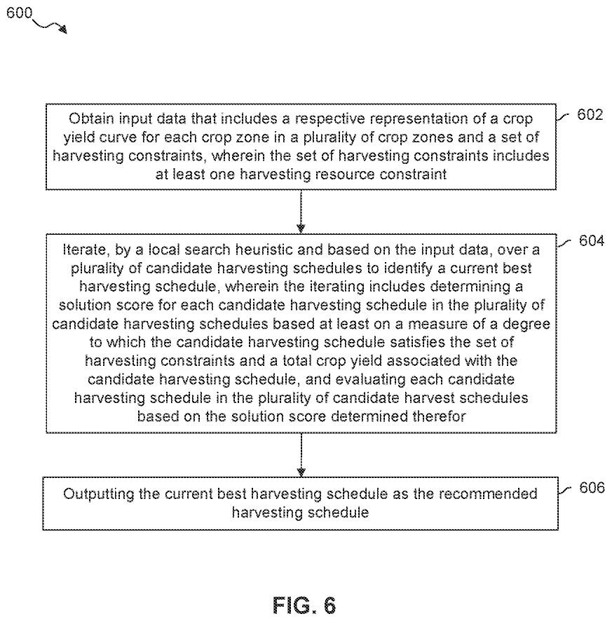

FIG. 6 is a flowchart of a method 600 for generating a recommended harvesting schedule, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to system 400 of FIG. 4. However, method 600 is not limited to that example embodiment.

In 602, input data preprocessor 404 obtains input data 406 that includes a respective representation of a crop yield curve for each crop zone in a plurality of crop zones and a set of harvesting constraints, wherein the set of harvesting constraints include at least one harvesting resource constraint.

In 604, local search heuristic 412 iterates, based on input data 406, over a plurality of candidate harvesting schedules to identify a current best harvesting schedule, wherein the iterating includes determining a solution score for each candidate harvesting schedule in the plurality of candidate harvesting schedules based at least on a measure of a degree to which the candidate harvesting schedule satisfies the set of harvesting constraints and a total crop yield associated with the candidate harvesting schedule, and evaluating each candidate harvesting schedule in the plurality of candidate harvest schedules based on the solution score determined therefor.

In 606, local search heuristic 412 outputs the current best harvesting schedule as recommended harvesting schedule 414.

In embodiments, each candidate harvesting schedule in the plurality of candidate harvesting schedules evaluated in 604 specifies, for each crop zone in the plurality of crop zones and for each time slot in a plurality of time slots that comprise a planning horizon, whether a harvesting task is to be carried out in the crop zone during the time slot and, in a case where a harvesting task is to be carried out in the crop zone during the time slot, a number of harvesting resources that are allocated to the harvesting task.

In further embodiments, the set of harvesting constraints obtained in 602 includes one or more of a harvesting resource availability per time slot, a planning horizon start time and a planning horizon end time, a minimum duration of a harvesting task, a number of working hours per day, a maximum number of harvesting tasks into which harvesting of a crop zone can be split, or a maximum number of harvesting resources that can work on one harvesting task per crop zone.

In still further embodiments, obtaining the respective representation of a crop yield curve for each crop zone in the plurality of crop zones in 602 comprises mapping yield values from a crop yield curve comprising a time series of data points to a series of timeslots associated with a planning horizon, wherein the mapping comprises performing one or more of an extrapolation technique or an interpolation technique.

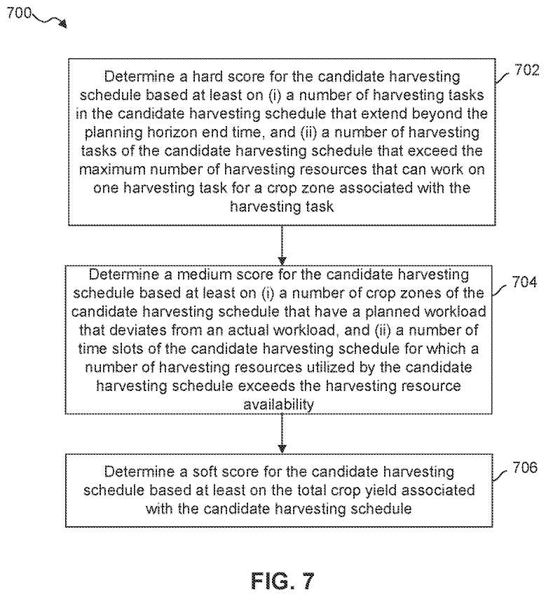

FIG. 7 is a flowchart of a method 700 for calculating a solution score associated with a candidate harvesting schedule, according to some embodiments. Method 700 may be used, for example, to implement 604 of method 600. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

Method 700 shall be described with reference to system 400 of FIG. 4. However, method 700 is not limited to that example embodiment.

In 702, local search heuristic 412 determines a hard score for the candidate harvesting schedule based at least on (i) a number of harvesting tasks in the candidate harvesting schedule that extend beyond the planning horizon end time and (ii) a number of harvesting tasks of the candidate harvesting schedule that exceed the maximum number of harvesting resources that can work on one harvesting task for a crop zone associated with the harvesting task.

In 704, local search heuristic 412 determines a medium score for the candidate harvesting schedule based at least on (i) a number of crop zones of the candidate harvesting schedule that have a planned workload that deviates from an actual workload and (ii) a number of time slots of the candidate harvesting schedule for which a number of harvesting resources utilized by the candidate harvesting schedule exceeds the harvesting resource availability.

In 706, local search heuristic 412 determines a soft score for the candidate harvesting schedule based at least on the total crop yield associated with the candidate harvesting schedule.

In embodiments that implement method 700, iterating, based on the input data, over the plurality of candidate harvesting schedules in 604 of method 600 may comprise iteratively selecting, as the current best harvesting schedule, candidate harvesting schedules with solution scores that are deemed relatively improved, wherein the selecting comprises prioritizing an improvement in the hard score over an improvement in the medium score or an improvement in the soft score, and prioritizing an improvement in the medium score over an improvement in the soft score.

In further embodiments, determining the solution score for each candidate harvesting schedule in the plurality of candidate harvesting schedules in 604 of method 600 may comprise: multiplying a measure of a degree to which the candidate harvesting schedule satisfies a first harvesting constraint by a first weight to determine a first solution score contribution, multiplying a measure of a degree to which the candidate harvesting schedule satisfies a second harvesting constraint by a second weight to determine a second solution score contribution, and determining the solution score for the candidate harvesting schedule based at least on the first solution score contribution and the second score contribution, wherein the first weight and the second weight are configurable by a user. For example, the first and second weights may be any two of c₁-c₄ as described above in reference to FIG. 4, and the corresponding measures may comprise the corresponding ones of h₁-h₄.

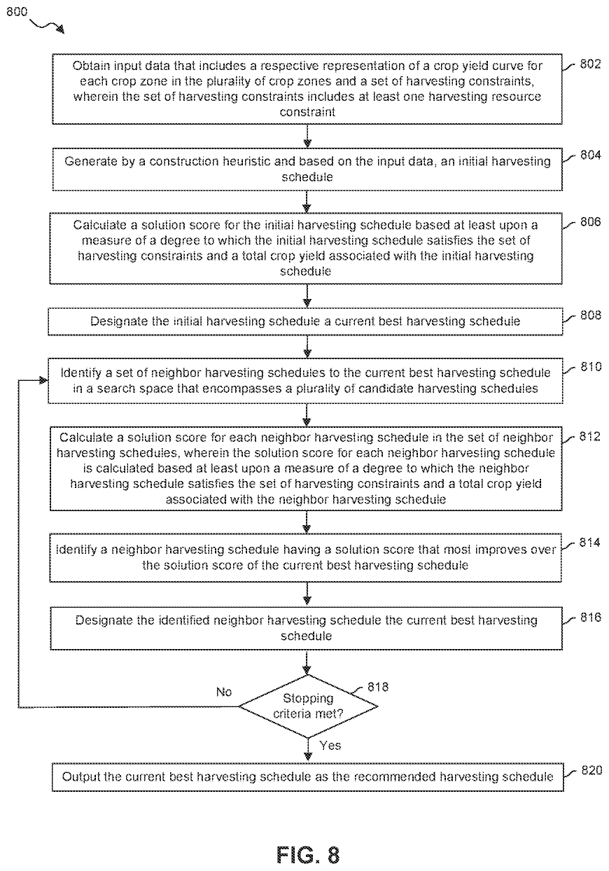

FIG. 8 is a flowchart for a method 800 for generating a recommended harvesting schedule, according to embodiments. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art.

Method 800 shall be described with reference to FIG. 4. However, method 800 is not limited to that example embodiment.

In 802, input data preprocessor 404 obtains input data 406 that includes a respective representation of a crop yield curve for each crop zone in a plurality of crop zones and a set of harvesting constraints, wherein the set of harvesting constraints include at least one harvesting resource constraint.

In 804, construction heuristic 408 generates, based on input data 406, initial harvesting schedule 410.

In 806, local search heuristic 412 (or another component of system 400) calculates a solution score for initial harvesting schedule 410 based at least upon a measure of a degree to which initial harvesting schedule 410 satisfies the set of harvesting constraints and a total crop yield associated with initial harvesting schedule 410.

In 808, local search heuristic 412 designates initial harvesting schedule 410 as a current best harvesting schedule.

In 810, local search heuristic 412 identifies a set of neighbor harvesting schedules to the current best harvesting schedule in a search space that encompasses a plurality of candidate harvesting schedules.

In 812, local search heuristic 412 calculates a solution score for each neighbor harvesting schedule in the set of neighbor harvesting schedules, wherein the solution score for each neighbor harvesting schedule is calculated based at least upon a measure of a degree to which the neighbor harvesting schedule satisfies the set of harvesting constraints and a total crop yield associated with the neighbor harvesting schedule.

In 814, local search heuristic 412 identifies a neighbor harvesting schedule having a solution score that most improves over the solution score of the current best harvesting schedule.

In 816, local search heuristic 412 designates the identified neighbor harvesting schedule as the current best harvesting schedule.

In 818, local search heuristic 412 determines if a stopping criterion has been met. If local search heuristic 412 determines that the stopping criterion has not been met, then control flows to 810 and local search heuristic will perform another iteration of 810, 812, 814 and 816. However, if local search heuristic 412 determines that the stopping criterion has been met, then in 820, local search heuristic 412 outputs the current best harvesting schedule as recommended harvesting schedule 414.

Various embodiments may be implemented, for example, using one or more well-known computer systems, such as computer system 900 shown in FIG. 9. One or more computer systems 900 may be used, for example, to implement any of the embodiments discussed herein, as well as combinations and sub-combinations thereof.

Computer system 900 may include one or more processors (also called central processing units, or CPUs), such as a processor 904. Processor 904 may be connected to a communication infrastructure or bus 906.

Computer system 900 may also include user input/output device(s) 903, such as monitors, keyboards, pointing devices, etc., which may communicate with communication infrastructure 906 through user input/output interface(s) 902.

One or more of processors 904 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of removable storage unit 922 and interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or variable, but every embodiment can not necessarily include the particular feature, structure, or variable. Moreover, such phrases are not necessarily referring to the same embodiment. Further, when a particular feature, structure, or variable is described in connection with an embodiment, it would be within the knowledge of persons skilled in the relevant art(s) to incorporate such feature, structure, or variable into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for generating a recommended harvesting schedule for harvesting a plurality of crop zones utilizing a plurality of harvesting resources, comprising:
obtaining input data that includes a respective representation of a crop yield curve for each crop zone in the plurality of crop zones and a set of harvesting constraints, wherein the set of harvesting constraints includes at least one harvesting resource constraint;
iterating, by a local search heuristic and based on the input data, over a plurality of candidate harvesting schedules to identify a current best candidate harvesting schedule, wherein the iterating includes:
determining a solution score for each candidate harvesting schedule in the plurality of candidate harvesting schedules based at least on a measure of a degree to which the candidate harvesting schedule satisfies the set of harvesting constraints and a total crop yield associated with the candidate harvesting schedule, and
evaluating each candidate harvesting schedule in the plurality of candidate harvest schedules based on the solution score determined therefor; and
outputting the current best harvesting schedule as the recommended harvesting schedule.

2. The computer-implemented method of claim 1, wherein each candidate harvesting schedule in the plurality of candidate harvesting schedules specifies for each crop zone in the plurality of crop zones and for each time slot in a plurality of time slots that comprise a planning horizon:
whether a harvesting task is to be carried out in the crop zone during the time slot; and
in a case where a harvesting task is to be carried out in the crop zone during the time slot, a number of harvesting resources that are allocated to the harvesting task.

3. The computer-implemented method of claim 2, wherein the set of harvesting constraints includes one or more of:
a harvesting resource availability per time slot;
a planning horizon start time and a planning horizon end time;
a minimum duration of a harvesting task;
a number of working hours per day;
a maximum number of harvesting tasks into which harvesting of a crop zone can be split; or
a maximum number of harvesting resources that can work on one harvesting task per crop zone.

4. The computer-implemented method of claim 3, wherein determining the solution score for each candidate harvesting schedule in the plurality of candidate harvesting schedules comprises;
determining a hard score for the candidate harvesting schedule based at least on a number of harvesting tasks in the candidate harvesting schedule that extend beyond the planning horizon end time and a number of harvesting tasks of the candidate harvesting schedule that exceed the maximum number of harvesting resources that can work on one harvesting task for a crop zone associated with the harvesting task;
determining a medium score for the candidate harvesting schedule based at least on a number of crop zones of the candidate harvesting schedule that have a planned workload that deviates from an actual workload and a number of time slots of the candidate harvesting schedule for which a number of harvesting resources utilized by the candidate harvesting schedule exceeds the harvesting resource availability; and
determining a soft score for the candidate harvesting schedule based at least on the total crop yield associated with the candidate harvesting schedule.

5. The computer-implemented method of claim 4, wherein iterating, by the local search heuristic and based on the input data, over the plurality of candidate harvesting schedules comprises:
iteratively selecting, as the current best harvesting schedule, candidate harvesting schedules with solution scores that are deemed relatively improved, wherein the selecting comprises prioritizing an improvement in the hard score over an improvement in the medium score or an improvement in the soft score, and prioritizing an improvement in the medium score over an improvement in the soft score.

6. The computer implemented method of claim 1, wherein determining the solution score for each candidate harvesting schedule in the plurality of candidate harvesting schedules comprises:
multiplying a measure of a degree to which the candidate harvesting schedule satisfies a first harvesting constraint by a first weight to determine a first solution score contribution;
multiplying a measure of a degree to which the candidate harvesting schedule satisfies a second harvesting constraint by a second weight to determine a second solution score contribution; and
determining the solution score for the candidate harvesting schedule based at least on the first solution score contribution and the second solution score contribution;
wherein the first weight and the second weight are configurable by a user.

7. The computer-implemented method of claim 1, wherein obtaining the respective representation of a crop yield curve for each crop zone in the plurality of crop zones comprises:
mapping yield values from a crop yield curve comprising a time series of data points to a series of timeslots associated with a planning horizon, wherein the mapping comprises performing one or more of an extrapolation technique or an interpolation technique.

8. A system for generating a recommended harvesting schedule for harvesting a plurality of crop zones utilizing a plurality of harvesting resources, comprising:
a memory; and
at least one processor coupled to the memory and configured to:
obtain input data that includes a respective representation of a crop yield curve for each crop zone in the plurality of crop zones and a set of harvesting constraints, wherein the set of harvesting constraints includes at least one harvesting resource constraint;
generate, by a construction heuristic and based on the input data, an initial harvesting schedule;
calculate a solution score for the initial harvesting schedule based at least on a measure of a degree to which the initial harvesting schedule satisfies the set of harvesting constraints and a total crop yield associated with the initial harvesting schedule;
designate the initial harvesting schedule as a current best harvesting schedule;
by a local search heuristic:
(i) identify a set of neighbor harvesting schedules to the current best harvesting schedule in a search space that encompasses a plurality of candidate harvesting schedules;
(ii) calculate a solution score for each neighbor harvesting schedule in the set of neighbor harvesting schedules, wherein the solution score for each neighbor harvesting schedule is calculated based at least on a measure of a degree to which the neighbor harvesting schedule satisfies the set of harvesting constraints and a total crop yield associated with the neighbor harvesting schedule;
(iii) identify a neighbor harvesting schedule having a solution score that most improves over the solution score of the current best harvesting schedule;
(iv) designate the identified neighbor harvesting schedule as the current best harvesting schedule;
(v) iteratively repeat (i)-(iv) until a stopping criterion is met; and
output the current best harvesting schedule as the recommended harvesting schedule.

9. The system of claim 8, wherein each candidate harvesting schedule in the plurality of candidate harvesting schedules specifies for each crop zone in the plurality of crop zones and for each time slot in a plurality of time slots that comprise a planning horizon:
whether a harvesting task is to be carried out in the crop zone during the time slot; and
in a case where a harvesting task is to be carried out in the crop zone during the time slot, a number of harvesting resources that are allocated to the harvesting task.

10. The system of claim 9, wherein the set of harvesting constraints includes one or more of:
a harvesting resource availability per time slot;
a planning horizon start time and a planning horizon end time;
a minimum duration of a harvesting task;
a number of working hours per day;
a maximum number of harvesting tasks into which harvesting of a crop zone can be split; or
a maximum number of harvesting resources that can work on one harvesting task per crop zone.

11. The system of claim 10, wherein the at least one processor is configured to calculate the solution score for a neighbor harvesting schedule in the set of neighbor harvesting schedules by:
determining a hard score for the neighbor harvesting schedule based at least on a number of harvesting tasks in the neighbor harvesting schedule that extend beyond the planning horizon end time and a number of harvesting tasks of the neighbor harvesting schedule that exceed the maximum number of harvesting resources that can work on one harvesting task for a crop zone associated with the harvesting task;
determining a medium score for the neighbor harvesting schedule based at least on a number of crop zones of the candidate harvesting schedule that have a planned workload that deviates from an actual workload and a number of time slots of the neighbor harvesting schedule for which a number of harvesting resources utilized by the neighbor harvesting schedule exceeds the harvesting resource availability; and
determining a soft score for the neighbor harvesting schedule based at least on the total crop yield associated with the neighbor harvesting schedule.

12. The system of claim 11, wherein the at least one processor is configured to identify the neighbor harvesting schedule having the solution score that most improves over the solution score of the current best harvesting schedule by prioritizing an improvement in the hard score over an improvement in the medium score or an improvement in the soft score, and prioritizing an improvement in the medium score over an improvement in the soft score.

13. The system of claim 8, wherein the at least one processor is configured to calculate the solution score for a neighbor harvesting schedule in the set of neighbor harvesting schedules by:
multiplying a measure of a degree to which the neighbor harvesting schedule satisfies a first harvesting constraint by a first weight to determine a first solution score contribution;
multiplying a measure of a degree to which the neighbor harvesting schedule satisfies a second harvesting constraint by a second weight to determine a second solution score contribution; and
determining the solution score for the neighbor harvesting schedule based at least on the first solution score contribution and the second solution score contribution;
wherein the first weight and the second weight are configurable by a user.

14. The system of claim 8, wherein the at least one processor is configured to obtain the respective representation of a crop yield curve for each crop zone in the plurality of crop zones by:
mapping yield values from a crop yield curve comprising a time series of data points to a series of timeslots associated with a planning horizon, wherein the mapping comprises performing one or more of an extrapolation technique or an interpolation technique.

15. A non-transitory computer-readable device having instructions stored thereon that, when executed by at least one computing device, cause the at least one computing device to perform operations for generating a recommended harvesting schedule for harvesting a plurality of crop zones utilizing a plurality of harvesting resources, the operations comprising:
obtaining input data that includes a respective representation of a crop yield curve for each crop zone in the plurality of crop zones and a set of harvesting constraints, wherein the set of harvesting constraints includes at least one harvesting resource constraint;
iterating, by a local search heuristic and based on the input data, over a plurality of candidate harvesting schedules to identify a current best candidate harvesting schedule, wherein the iterating includes:
determining a solution score for each candidate harvesting schedule in the plurality of candidate harvesting schedules based at least on a measure of a degree to which the candidate harvesting schedule satisfies the set of harvesting constraints and a total crop yield associated with the candidate harvesting schedule, and
evaluating each candidate harvesting schedule in the plurality of candidate harvest schedules based on the solution score determined therefor; and
outputting the current best harvesting schedule as the recommended harvesting schedule.

16. The non-transitory computer-readable device of claim 15, wherein each candidate harvesting schedule in the plurality of candidate harvesting schedules specifies for each crop zone in the plurality of crop zones and for each time slot in a plurality of time slots that comprise a planning horizon:
whether a harvesting task is to be carried out in the crop zone during the time slot; and
in a case where a harvesting task is to be carried out in the crop zone during the time slot, a number of harvesting resources that are allocated to the harvesting task.

17. The non-transitory computer-readable device of claim 16, wherein the set of harvesting constraints includes one or more of:
a harvesting resource availability per time slot;
a planning horizon start time and a planning horizon end time;
a minimum duration of a harvesting task;
a number of working hours per day;
a maximum number of harvesting tasks into which harvesting of a crop zone can be split; or
a maximum number of harvesting resources that can work on one harvesting task per crop zone.

18. The non-transitory computer-readable device of claim 17, wherein determining the solution score for each candidate harvesting schedule in the plurality of candidate harvesting schedules comprises:
determining a hard score for the candidate harvesting schedule based at least on a number of harvesting tasks in the candidate harvesting schedule that extend beyond the planning horizon end time and a number of harvesting tasks of the candidate harvesting schedule that exceed the maximum number of harvesting resources that can work on one harvesting task for a crop zone associated with the harvesting task;
determining a medium score for the candidate harvesting schedule based at least on a number of crop zones of the candidate harvesting schedule that have a planned workload that deviates from an actual workload and a number of time slots of the candidate harvesting schedule for which a number of harvesting resources utilized by the candidate harvesting schedule exceeds the harvesting resource availability, and
determining a soft score for the candidate harvesting schedule based at least on the total crop yield associated with the candidate harvesting schedule.

19. The non-transitory computer-readable device of claim 18, wherein iterating, by the local search heuristic and based on the input data, over the plurality of candidate harvesting schedules comprises:
iteratively selecting, as the current best harvesting schedule, candidate harvesting schedules with solution scores that are deemed relatively improved, wherein the selecting comprises prioritizing an improvement in the hard score over an improvement in the medium score or an improvement in the soft score, and prioritizing an improvement in the medium score over an improvement in the soft score.

20. The non-transitory computer-readable device of claim 15, wherein determining the solution score for each candidate harvesting schedule in the plurality of candidate harvesting schedules comprises:
multiplying a measure of a degree to which the candidate harvesting schedule satisfies a first harvesting constraint by a first weight to determine a first solution score contribution;
multiplying a measure of a degree to which the candidate harvesting schedule satisfies a second harvesting constraint by a second weight to determine a second solution score contribution; and
determining the solution score for the candidate harvesting schedule based at least on the first solution score contribution and the second solution score contribution;
wherein the first weight and the second weight are configurable by a user.
